(19) United States
(12) Patent Application Publication
(10) Pub. No.: US 2026/0316604 A1
(43) Pub. Date: Oct. 15, 2026

(54) POWER UNIT, LOAD HANDLING DEVICE, SYSTEM, AND METHOD

(71) Applicant: Ocado Innovation Limited, Hatfield, Hertfordshire (GB)

(72) Inventors: Malte GRUBER, Stockholm (SE); Mathias NORDQVIST, Hatfield (GB)

(21) Appl. No.: 19/675,708

(22) Filed: May 13, 2026

Related U.S. Application Data
(63) Continuation of application No. PCT/EP2024/085037, filed on Dec. 6, 2024.

(30) Foreign Application Priority Data
Dec. 8, 2023 (GB) 2318776.8

(51) Int. Cl. B60L 53/122; B60L 53/18; B60L 53/30; B60L 53/36; B60L 53/38; B60L 53/66; B60L 53/80

(52) U.S. Cl. CPC B60L 53/122; B60L 53/18; B60L 53/305; B60L 53/36; B60L 53/38; B60L 53/66; B60L 53/80; B60L 2200/40

(57) ABSTRACT

A power unit for providing power to a load handling device operative on a grid framework structure is configured to transfer power to the load handling device, and to receive power from a power supply. The power unit can be lifted into the load handling device so that power is transferred from the power supply to the load handling device via the power unit. The load handling device includes one or more critical components that are required to be operational at all times while the load handling device is on the grid framework structure. An exchange station is provided for exchanging power sources in a load handling device. The exchange station includes a transfer mechanism for removing/inserting a power source from/into the load handling device, and a power unit.

### RELATED APPLICATIONS

This application is a continuation application of International Patent Application No. PCT/EP2024/085037 filed 6 Dec. 2024 and entitled “Power unit, load handling device, system, and method,” which claims priority to UK Patent Application No. GB2318776.8 filed 8 Dec. 2023 and entitled “Power unit, load handling device, system, and method”; the entire contents of both of which applications are incorporated herein by reference.

### TECHNICAL FIELD

The present disclosure relates to a power unit for use with a load handling device on a grid framework structure, and a method for using the power unit. The grid framework structure comprises a supporting framework structure upon which is mounted a track system that supports remotely operated load handling devices for handling storage containers stacked in the grid framework structure.

### BACKGROUND

WO2015/185628A2 describes a storage and retrieval system in which stacks of storage containers are arranged within a grid framework structure. The grid framework structure comprises a supporting framework structure upon which is mounted a track system that supports remotely operated load handling devices for handling storage containers stacked in the grid framework structure.

Load handling devices are typically powered by rechargeable power sources, for example rechargeable batteries. The rechargeable power sources, once depleted, either need to be recharged or replaced in order to permit the load handling device to continue operating. Charging can take a significant amount of time, and reduce the useful operational time of the load handling devices. Charging can be wired or wireless.

Charging a load handling device can be done via a power receiving element on the load handling device, which needs to be brought into close proximity with the charger. If the charge receiving element is positioned on a side of the load handling device, the correct side needs to be facing the charger in order for the load handling device to be charged. This limits the direction in which the load handling device can approach the charge station. Since the load handling device can move in any direction on the grid but cannot turn, if a power receiving element is located on one side of the load handling device, the load handling device can only charge if approaching a charger in one direction such that the power receiving element faces the charger. The charger could be located on any side of the track system. To address this problem, the load handling device could be provided with power receiving elements on all four sides, but this has the disadvantage of requiring more parts, with the associated increase in complexity, weight, and cost. Furthermore, in order to charge, the load handling device would need to be able to park with a high degree of accuracy and precision next to the charger.

Another way to solve the problem of downtime during charging is for the power sources in the load handling device to be exchangeable, so that a depleted power source can be exchanged for a fully charged power source at an exchange station. This solution does, however, have the disadvantage that there is an interruption in power supply to the load handling device while the power source is being exchanged. This can be a problem for electronic components that need to be powered continuously (e.g. communications, control systems, sensors). The load handling device can be provided with an auxiliary power source to maintain the power supply during the exchange operation, but this requires extra parts, with an associated increase in cost, weight, and complexity of the load handling device.

Another consideration is that load handling devices may be equipped with sensors that record data, which needs to be transferred from the load handling device, along with other data such as diagnostic data and error logs.

A solution is therefore needed that improves the operational efficiency of the load handling devices by reducing the time required to recharge, while maintaining power supply to critical components of the load handling device.

### SUMMARY

A power unit for providing power to a load handling device operative on a grid framework structure is provided, the power unit comprising:
a power providing element configured to transfer power to at least one power receiving element in the load handling device; and
a power receiving element configured to receive power from a power supply;
wherein the power unit is configured to be lifted into a container-receiving space of the load handling device such that, when received within the container receiving space of the load handling device, power is transferred from the power supply to the load handling device via the power unit.

An advantage of the power unit being lifted into the container receiving space of the load handling device is that the problem of how to make the power connection is already solved, since the load handling device is designed to lift a storage container into the container receiving space with a high degree of accuracy. A pre-existing feature is used to perform a new function, thus solving the problem of how to make the power connection without requiring a significant number of new parts or a significant amount of design effort. The load handling device's own power is used to perform the connection. Also, unlike a power receiving element on the side of a load handling device where the power connection is reliant on carefully aligning the load handling device with a charger, using the load handling device to lift the power unit ensures that the power receiving element is sufficiently aligned with the power providing element to facilitate power transfer.

The power unit may comprise one or more engagement features configured to be engaged by a container-engaging assembly of the load handling device. Engagement features can take any suitable form, for example apertures, a rim or lip, hooks, magnets, or any other feature that enables the container-engaging assembly to engage with the power unit.

The power transfer from the power supply to the power unit happens simultaneously with the power transfer from the power unit to the load handling device. The power unit is effectively acting as a conduit to enable power to be transferred form the power supply to the load handling device.

An alignment mechanism can be used to fine-tune the relative positions and ensure a good connection between the power providing element of the power unit and the power receiving element of the load handling device. For example, one or more locating pins may be provided in the vicinity of the power providing element and corresponding tapered holes in the vicinity of the power receiving element, or the other way round, so that as the power providing element approaches the power receiving element the locating pins enter the tapered holes and help to align the power providing element and the power receiving element.

The power receiving element of the power unit may be configured to receive power from the power supply via a cable. As well as providing power, the cable physically tethers the power unit in its storage column. The power supply can be located in or on or near the grid framework structure For example, the power supply may be located at the bottom of a storage column, or mounted on a member of the grid framework structure, or at an adjacent exchange station, or in any other suitable location.

The power receiving element of the power unit may be configured to receive power wirelessly from a power providing element connected to the power supply.

The power providing element and the power receiving element of the power unit may be configured to move relative to one another such that, when the power unit is received within the load-handling device, the power receiving element of the power unit is configured to align with the power providing element connected to the power supply such that power can be transferred.

For example, the power providing element of the power unit can be mounted on a power transfer head that is moveable relative to the body of the power unit, for example via a telescoping mechanism. This relative movement allows the power unit to receive power from the power supply and simultaneously provide power to the load handling device. In other examples, the power receiving element of the power unit can move relative to the body of the power unit.

The wireless power transfer between the power providing element connected to the power supply and the power receiving element of the power unit may be via magnetic induction.

The power transfer between the power unit and the load handling device may also be wireless. The power providing element of the power unit and the power receiving element of the load handling device may be induction coils, and the induction coil of the power unit may be configured to transfer power to the induction coil of the load handling device by magnetic induction.

Advantageously, wireless power transfer mitigates the problem of wear and tear on physical connectors. A large number of charging cycles is possible without any reduction in performance, and without durability becoming a problem.

The induction coil on the power unit may be printed onto a PCB. Advantages of using a PCB (printed circuit board) rather than wire coils include repeatability and consistency of manufacturing, a reduction in manufacturing errors, better power density, reduced labour cost, a simpler manufacturing process, flexibility in shape and geometry optimization, and ultimately a lighter and cheaper product.

The power unit may further comprise a data interface configured to transfer data between the power unit and the load handling device.

An advantage of the power unit being able to transfer data as well as power is that there is no need for a separate solution for data transfer. Data logs from sensors on the load handling device can be transferred out at the same time as transferring power, so the load handling device does not need to be equipped with a separate communication module for transferring data (e.g. wifi, Bluetooth, li-fi, cabled connections), and does not need a separate operation to offload data logs. Once the data is transferred to the power unit, a further data interface on the power unit can be used to transfer the data off the power unit, e.g. via an ethernet cable or wirelessly.

The data interface may be configured to support bidirectional data transfer between the power unit and the load handling device. Bidirectional data transfer is an advantage because the load handling device can be supplied with data (for example, computer executable code e.g. firmware updates or operational files) at the same time as downloading data (for example, sensor logs or diagnostic data) without the need for a separate operation and a separate data transfer method.

The data interface may comprise an induction coil configured to transfer data to and/or from a corresponding induction coil in the load handling device by magnetic induction.

The induction coil for data transfer on the power unit may be printed onto a PCB.

The induction coil for power transfer and the induction coil for data transfer may be printed onto the same PCB. This has the advantage of requiring fewer parts, so the system is simpler, lighter, and cheaper to manufacture.

Induction coils can take any appropriate shape, for example a square or circular spiral, or concentric squares or circles. A single layer can be printed onto a PCB, or multiple layers can be printed onto a PCB, in order to increase the number of turns on the coils and maximize power transfer. Spacers can be used between the PCBs for the transmitter and receiver circuits.

The same induction coils can be used to transfer both power and data. An advantage of this arrangement is that fewer parts are required, leading to a simpler design and a lighter product.

A load handling device for moving storage containers on a grid framework structure is provided, the load handling device comprising:
a wheel assembly;
one or more critical components that are required to be operational at all times while the load handling device is on the grid framework structure;
a container receiving space for receiving a storage container;
a lifting device configured to lift the storage container into the container receiving space;
a power receiving element configured to receive power from a power providing element of a power unit as defined herein;
wherein the lifting device is configured to lift the power unit into the container receiving space of the load handling device, such that the power receiving element of the load handling device receives sufficient power from the power providing element of the power unit to operate the one or more critical components of the load handling device.

The one or more critical components of the load handling device are components that should remain operational, even when there is no power source in the load handling device. For example, critical components can include a communications module, control system, data logging, diagnostics, and safety systems.

The power transfer between the power unit and the load handling device may also be wireless. The power receiving element of the load handling device and the power providing element of the power unit may be induction coils, and the induction coil of the load handling device may be configured to receive power from the induction coil of the power unit by magnetic induction. The induction coil of the load handling device may be printed onto a PCB.

The load handling device may further comprise a data interface configured to transfer data to or receive data from the power unit when the power unit is received in the container receiving space. The data interface may be configured to support bidirectional data transfer between the load handling device and the power unit.

The data interface may comprise an induction coil configured to transfer data to and/or from an induction coil in the load handling device by magnetic induction. The induction coil for data transfer of the load handling device may be printed onto a PCB. The induction coil for power transfer and the induction coil for data transfer may be printed onto the same PCB.

An exchange station for exchanging power sources in a load handling device is provided. The exchange station comprises:
a transfer mechanism for removing/inserting a power source from/into the load handling device;
a power unit as defined herein;
wherein the power unit is configured to provide sufficient power to operate one or more critical components of the load handling device while the power source is being exchanged.

An advantage of the exchange station is that there is no need for the load handling device to have an auxiliary power source to power the critical components when the power source is removed. A significant cost and weight saving can be made by not requiring an auxiliary power source.

The exchange station may comprise charging bays for charging power sources. The power supply for the power unit may be part of the exchange station, or the power supply may be shared with the exchange station.

Any suitable transfer mechanism can be used, for example a robot arm.

A storage and retrieval system is provided, comprising:
a grid framework structure comprising:
i) a track system comprising a plurality of tracks arranged in a grid pattern;
ii) a supporting framework structure supporting the track system; and
iii) a plurality of stacks of storage containers arranged in a plurality of storage columns located below the track system;
at least one load handling devices as defined herein;
at least one exchange stations as defined herein; and
at least one power supply for providing power to the power unit of the at least one exchange station.

The power unit is easy to integrate into an existing storage and retrieval system. The power unit can be located in a storage column adjacent or close to an exchange station, so that the power unit is within reach of the transfer mechanism. The power unit can be connected to the power supply via a cable, or can be provided with power via a power providing unit connected to the power supply.

Data transfer (for example, data logs from sensors on the load handling device) can occur at the same time as exchanging the power source, so the load handling device does not need to be equipped with a separate communication module for transferring data, and does not need a separate operation for data transfer.

A method of transferring power to a power source in a load handling device is provided. The method comprises the steps of:
a load handling device travelling to an exchange station;
the load handling device engaging with the power unit and lifting the power unit through a grid cell into the container receiving space of the load handling device; and
power being transferred from the power supply to the load handling device via the power unit.

The method may further comprise the step of the load handling device lowering the power unit until the power receiving element of the power unit is aligned with the power providing element connected to the power supply, while the power providing element of the load handling device remains engaged with the power providing element of the power unit, in order for power to be transferred from the power supply to the load handling device via the power unit.

The method may further comprise the step of data being transferred between the load handling device and the power unit.

The method may further comprise the steps of:
a first power source being removed from the load handling device;
a second power source being inserted into the load handling device; and
the load handling device returning the power unit to the grid cell;
such that the power unit provides sufficient power to operate the one or more critical components of the load handling device while the power source is being exchanged.

### BRIEF DESCRIPTION OF FIGURES

Further features and aspects of the present disclosure will be apparent from the following detailed description of illustrative embodiments made with reference to the drawings.

FIG. 1 schematically illustrates a grid framework structure and storage containers.

FIG. 2 schematically illustrates track on top of the grid framework structure illustrated in FIG. 1.

FIG. 3 schematically illustrates load handling devices on top of the grid framework structure illustrated in FIG. 1.

FIG. 4 schematically illustrates a single load handling device with lifting device in a lowered configuration.

FIG. 5 schematically illustrates cutaway views of a single load handling device with lifting device in a raised and a lowered configuration.

FIG. 6 is a perspective view of an example of a known lifting device.

FIG. 7 is a perspective side view of a known container-engaging assembly.

FIG. 8 is a perspective bottom view of a known container-engaging assembly.

FIG. 9a schematically illustrates an example of a power unit in a grid framework structure, and a load handling device with the container-engaging assembly within the container receiving space.

FIG. 9b schematically illustrates the power unit, grid framework structure, and load handling device of FIG. 9a, with the container-engaging assembly lowered into the storage column towards the power unit.

FIG. 9c schematically illustrates the power unit, grid framework structure, and load handling device of FIG. 9a, with the container-engaging assembly engaging the power unit.

FIG. 9d schematically illustrates the power unit, grid framework structure, and load handling device of FIG. 9a, with the container-engaging assembly and the power unit being lifted up through the storage column.

FIG. 9e schematically illustrates the power unit, grid framework structure, and load handling device of FIG. 9a, with the power unit received within the container-receiving space.

FIG. 10 schematically illustrates another example of a power unit, grid framework structure, and load handling device, where the load handling device is charged wirelessly via the power unit.

FIG. 11a illustrates an example of power and data connections for a load handing device, in exploded view.

FIG. 11b illustrates the example of FIG. 11a in assembled view.

FIG. 12a illustrates an example of power and data connections for a power unit, complementary to the connections for a load handling device illustrated in FIGS. 11a and 11b, in exploded view.

FIG. 12b illustrates the example of FIGS. 12a and 12b in assembled view.

FIG. 13a illustrates the power and data connections of FIGS. 11a, 11b, 12a, and 12b separately.

FIG. 13a illustrates the power and data connections of FIGS. 11a, 11b, 12a, and 12b in engagement.

FIG. 14 illustrates the container engaging assembly of a load handling device, and a power unit.

FIG. 15 is a block diagram schematically illustrating a wireless power transfer system.

FIG. 16a illustrates an example of commercially available induction coils, illustrated separately.

FIG. 16b illustrates the coils of FIG. 16b close together with magnetic flux lines.

FIG. 17 schematically illustrates a pair of induction coils with a ferrite backing material.

FIG. 18 is a graph of Q-factor against frequency for the induction coils illustrated in FIGS. 16a and 16b.

FIG. 19 is a flowchart describing a method of exchanging a power source in a load handling device.

### DETAILED DESCRIPTION

The following embodiments represent the applicant's preferred examples of how to implement the power unit, but they are not necessarily the only examples of how that could be achieved.

### Grid Framework Structure

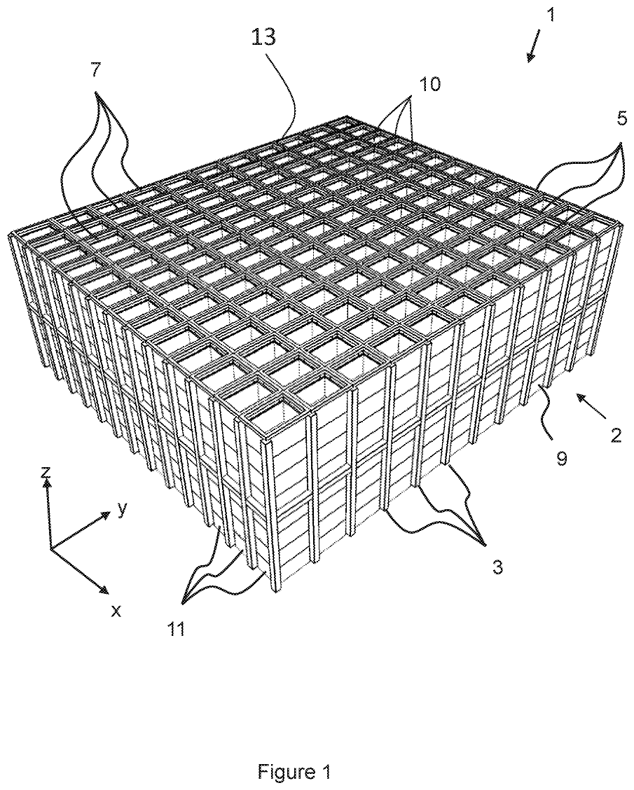

FIG. 1 illustrates a grid framework structure 1 comprising a supporting framework structure 2 supporting a track structure 13. The supporting framework structure 2 can take any suitable form. In the specific example illustrated in FIG. 1, the supporting framework structure 2 comprises a plurality of upright members 3 and horizontal members 5, 7 which are supported by the upright members 3. Upright members 3 may also be referred to as upright columns 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells. In the illustrated example, storage containers 9 are arranged in stacks 11 beneath the grid cells defined by the grid pattern, one stack 11 of storage containers 9 per grid cell.

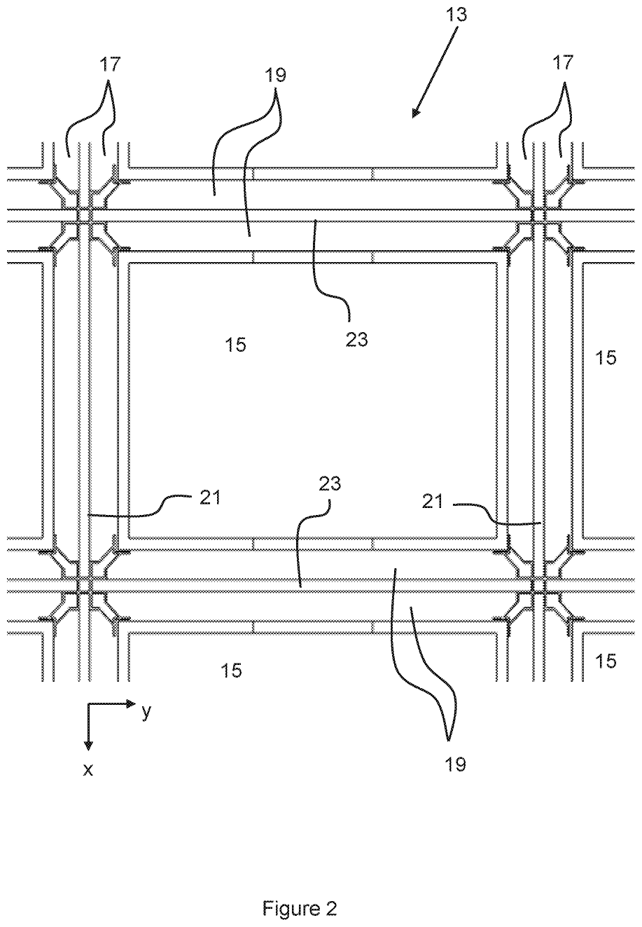

FIG. 2 shows a large-scale plan view of a section of track structure 13 forming part of the grid framework structure 1 illustrated in FIG. 1 and located on top of the horizontal members 5, 7 of the grid framework structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow storage containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure may also be possible.

As an alternative to the supporting framework structure 2 as described with reference to FIG. 1, in other examples the support framework structure comprises a plurality of prefabricated 5 modular panels arranged in a grid pattern, the detail of which is described briefly below and fully in PCT patent application number, WO2022034195A1, in the name of Ocado Innovation Ltd, and counterpart published US patent application number US2025/0066120, the entire content of which is incorporated herein by reference. This grid framework structure 1 described in WO2022034195A1 and US2025/0066120 addresses the problem of time and cost to assemble by providing a supporting framework structure 2 comprising a plurality of prefabricated modular panels 10 arranged in a three-dimensional grid pattern to define a plurality of grid cells. Each of the grid cells of the supporting framework structure 2 is sized to support two or more grid cells of the track system 13. The grid framework structure 1 is formed from fewer structural components yet still maintains the same structural integrity as the typical “stick-built” grid framework structure 1 described above, and is much faster and cheaper to build.

Any appropriate supporting framework structure 2 can be used in the current invention.

### Load Handling Device

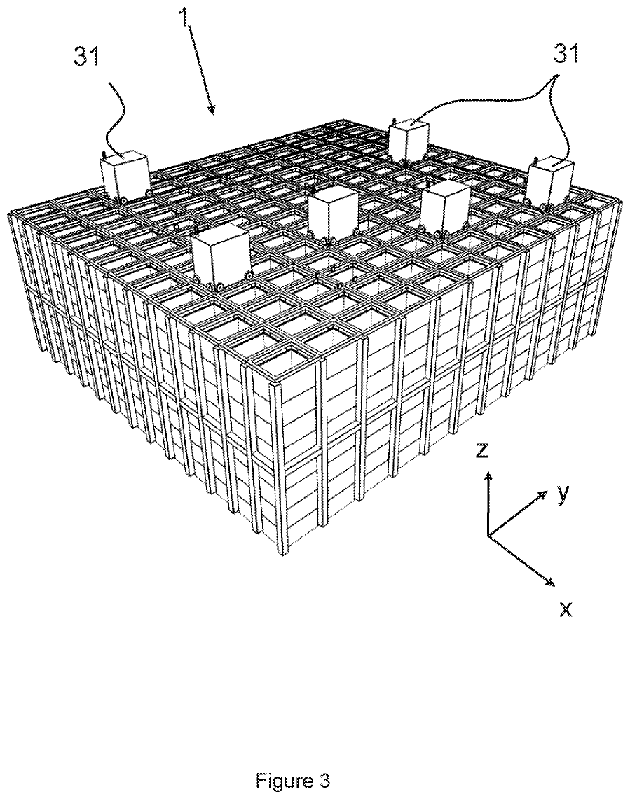

FIG. 3 shows a plurality of load handling devices 31 moving on top of the grid framework structure 1 illustrated in FIG. 1. The load handling devices 31, which may also be referred to as robots 31 or bots 31, are provided with sets of wheels to engage with corresponding x-or y-direction tracks 17, 19 to enable the load handling devices 31 to travel across the track structure 13 and reach specific grid cells. The illustrated pairs of tracks 17, 19 separated by channels 21, 23 allow load handling devices 31 to occupy (or pass one another on) neighbouring grid cells without colliding with one another.

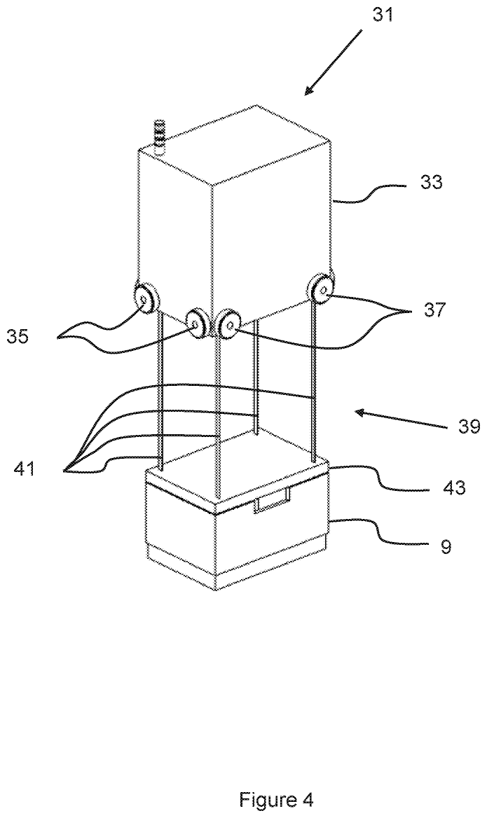

As illustrated in detail in FIG. 4, a load handling device 31 comprises a body 33 in or on which are mounted one or more components which enable the load handling device 31 to perform its intended functions. These functions may include moving across the grid framework structure 1 on the track structure 13 and raising or lowering containers 9 (e.g. from or to stacks 11) so that the load handling device 31 can retrieve or deposit containers 9 in specific locations defined by the grid pattern.

The load handling device 31 comprises a wheel assembly 34. The embodiment of the load handling device 31 illustrated in FIG. 4 comprises first and second sets of wheels 35, 37 which are mounted on the body 33 of the load handling device 31 and enable the load handling device 31 to move in the x- and y-directions along the tracks 17 and 19, respectively. In particular, two wheels 35 are provided on the shorter side of the load handling device 31 visible in FIG. 4, and a further two wheels 35 are provided on the opposite shorter side of the load handling device 31 (side and further two wheels 35 not visible in FIG. 4). The wheels 35 engage with tracks 17 and are rotatably mounted on the body 33 of the load handling device 31 to allow the load handling device 31 to move along the tracks 17. Analogously, two wheels 37 are provided on the longer side of the bot 31 visible in FIG. 4, and a further two wheels 37 are provided on the opposite longer side of the load handling device 31 (side and further two wheels 37 not visible in FIG. 4). The wheels 37 engage with tracks 19 and are rotatably mounted on the body 33 of the load handling device 31 to allow the load handling device 31 to move along the tracks 19.

The wheel assembly 34 of the load handing device 31 may be driven by a driving mechanism 38. The driving mechanism 38 may comprise one or more motors.

The load handling device 31 also comprises lifting device 39 configured to raise and lower storage containers 9. The illustrated lifting device 39 comprises four tapes or reels 41 which are connected at their lower ends to a container-engaging assembly 43. The container-engaging assembly 43 comprises an engaging mechanism 42 (which may, for example, be provided at the corners of the assembly 43, in the vicinity of the tapes 41) configured to engage with features of the storage containers 9. For instance, the storage containers 9 may be provided with one or more apertures in their upper sides with which the engaging mechanism 42 can engage.

Alternatively or additionally, the engaging mechanism 42 may be configured to hook under the rims or lips of the storage containers 9, and/or to clamp or grasp the storage containers 9. The tapes 41 may be wound up or down to raise or lower the container-engaging assembly, as required. The lifting device 39 may be driven by a driving mechanism 38. The winding up or down of the tapes 41 of the lifting device 39 may be effected or controlled by the driving mechanism 38, which may comprise one or more motors or other means. The same driving mechanism 38 can be used to drive both the wheel assembly 34 and the lifting device 39, or separate driving mechanisms may be used for driving the wheel assembly and for driving the lifting device.

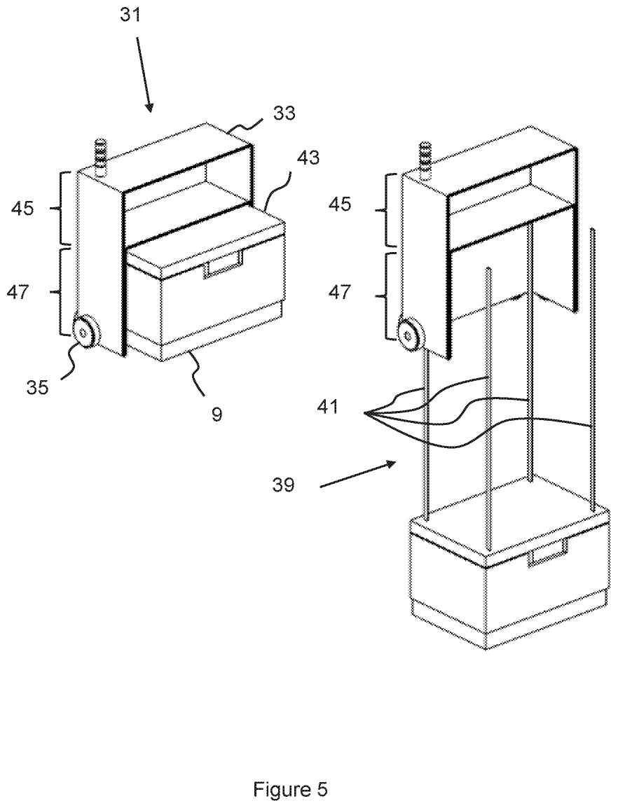

As can be seen in FIG. 5, the body 33 of the illustrated load handling device 31 has an upper portion 45 and a lower portion 47. The upper portion 45 is configured to house one or more operation components (not shown). The lower portion 47 is arranged beneath the upper portion 45. The lower portion 47 comprises a container-receiving space 49 or cavity for accommodating at least part of a storage container 9 that has been raised by the lifting device 39. The container-receiving space 49 is sized such that enough of a storage container 9 can fit inside the cavity to enable the load handling device 31 to move across the track structure 13 on top of grid framework structure 1 without the underside of the storage container 9 catching on the track structure 13 or another part of the grid framework structure 1. When the load handling device 31 has reached its intended destination, the lifting device 39 controls the tapes 41 to lower the container-engaging assembly 43 and the corresponding storage container 9 out of the container-receiving space 49 in the lower portion 47 and into the intended position. The intended position may be a stack 11 of storage containers 9 or an egress point of the grid framework structure 1 (or an ingress point of the grid framework structure 1 if the load handling device 31 has moved to collect a container 9 for grid framework in the grid framework structure 1). Although in the illustrated example the upper and lower portions 45, 47 are separated by a physical divider, in other embodiments, the upper and lower portions 45, 47 may not be physically divided by a specific component or part of the body 33 of the load handling device 31.

In some embodiments, the container-receiving space 49 of the load handling device 31 may not be within the body 33 of the bot 31. For example, in some embodiments, the container-receiving space 49 may be adjacent to the body 33 of the load handling device 31, e.g. in a cantilever arrangement with the weight of the body 33 of the load handling device 31 counterbalancing the weight of the container to be lifted. In such embodiments, a frame or arms of the lifting device 39 may protrude horizontally from the body 33 of the load handling device 31, and the tapes/reels 41 may be arranged at respective locations on the protruding frame/arms and configured to be raised and lowered from those locations to raise and lower a container into the container-receiving space 49 adjacent to the body 33. The height at which the frame/arms is/are mounted on and protrude(s) from the body 33 of the load handling device 31 may be chosen to provide a desired effect. For example, it may be preferable for the frame/arms to protrude at a high level on the body 33 of the load handling device 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the centre of mass of the load handling device 31 lower when the load handling device 31 is loaded with a container.

The specific example of a load handling device illustrated in FIGS. 4 and 5 shows the load handling device 31 with a body 33 that is substantially box-shaped with four sidewalls and a top wall, with the components of the load handling device 31 housed within the body 33. In other examples the body 33 may comprise an open frame or skeleton structure, within or upon which components of the load handling device 31 are supported.

To enable the load handling device 31 to move on the different wheels 35, 37 in the first and second directions, the load handling device 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the grid framework structure 1.

The wheel-positioning mechanism may include one or more linear actuators, rotary components or other means for raising and lowering at least one set of wheels 35, 37 relative to the body 33 of the load handling device 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the load handling device 31 stays substantially at the same height and therefore the weight of the body 33 and the components mounted thereon does not need to be lifted and lowered by the wheel-positioning mechanism.

The driving mechanism(s) 38 used to drive the wheel assembly 34 and the lifting device 39 can be powered by a main rechargeable power source 53.

In some examples, the grid framework structure 1 may comprise one or more port columns or vertical chutes to facilitate the entry or removal of storage containers from the grid framework structure. A port column occupies one grid cell 14, bounded at the four corners by four of the vertical uprights 3 of the grid framework structure 1. Vertical guides may be provided to guide the storage container 9 in a vertical direction. To remove a storage container 9 from the grid framework structure 1, a load handling device 31 carrying a storage container 9 in its container-receiving space 49 travels to the grid cell 14 at the top of the port column and lowers the storage container 9 down until the storage container 9 reaches the bottom of the port column. The container-engaging assembly 43 of the load handling device 31 then disengages from the storage container 9 and is lifted back into the body 33 of the load handling device. The storage container 9 at the bottom of the port column can then be removed, for example by a conveyor belt or vehicle or human operative.

To bring a storage container 9 into the grid framework structure 1, the same operation is used in reverse. The storage container 9 is brought to the bottom of a port column (for example, by a conveyor belt or vehicle or human operative). A load handling device 31 travels to the grid cell at the top of the port column and lowers its container-engaging assembly 43 down the port column. The container-engaging assembly engages with the storage container, and the lifting device 39 lifts the storage container 9 up through the port column and into the container-receiving space 49 of the load handling device 31. The load handling device then travels on the track structure to take the storage container to its destination location in the grid framework structure.

### Lifting Device

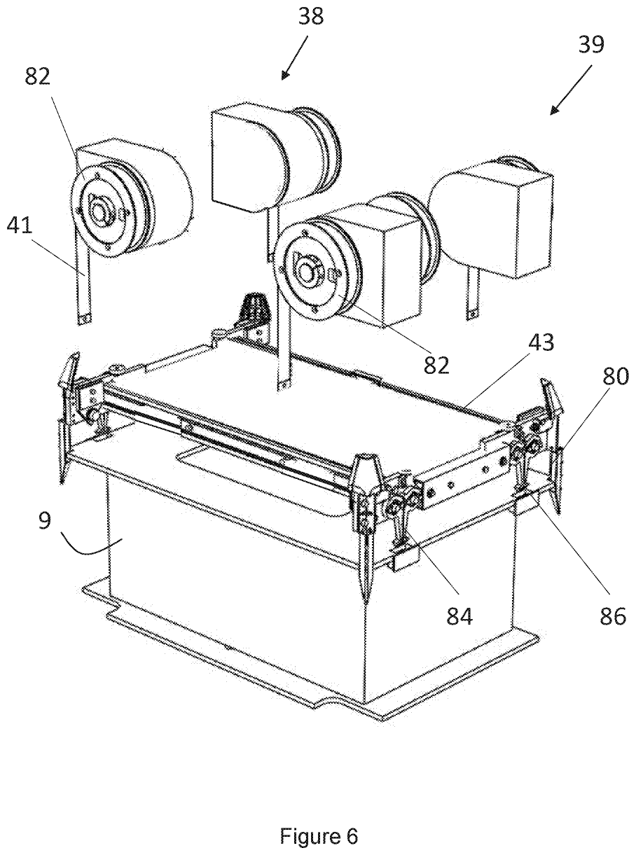

FIG. 6 shows a lifting device 39 known in the art comprising a container-engaging assembly 43, otherwise known as a grabber device, for releasably connecting to a storage container 9 below, and a driving mechanism 38 to raise and lower the container-engaging assembly 43. The driving mechanism 38 can be the same driving mechanism used to drive both the wheel assembly 34 and the lifting device 39, or separate driving mechanisms may be used.

To raise and lower the container-engaging assembly 43, the driving mechanism 38 known in the art comprises a set of lifting tapes or bands 41 extending in a vertical direction between the container-engaging assembly 43 and the driving mechanism 38. For maximum stability and load capacity, commonly four lifting tapes 41 wound on separate spools 82 are shown extending between the driving mechanism 38 and at each corner of the container-engaging assembly 43.

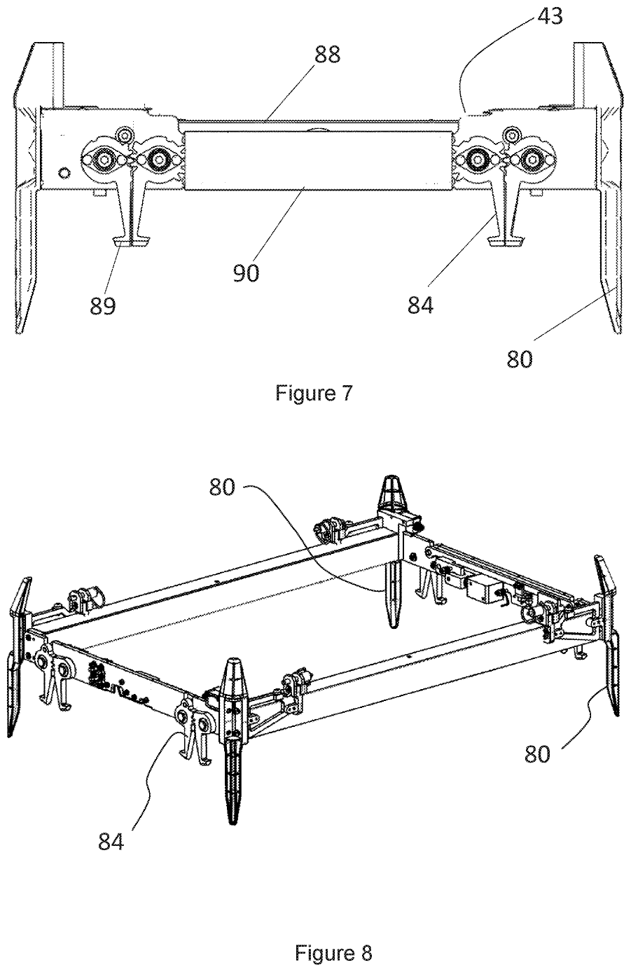

In an exemplary embodiment of the present invention, the container-engaging assembly 43 is formed as a frame having four corner sections, a top side 88 and a bottom side 90 (see FIG. 7). To grab a container 9, the container-engaging assembly 43 comprises four locating pins or guide pins 80 nearby or at each corner of the container-engaging assembly 43 which mate with corresponding cut outs or holes (not shown) formed at four corners of the container 9. Four gripper elements 84 arranged at the bottom side of the container-engaging assembly 43 to engage with the rim of the container 9 (see FIGS. 7 and 8). The locating pins 80 help to properly align the gripper elements 84 with corresponding holes or openings in the rim of the container 9. In the particular embodiment shown in FIG. 7, each of the gripper elements 84 comprises a pair of wings that are collapsible so as to be receivable in corresponding holes or openings 86 in the rim of the container 9 (see FIG. 6) and an open or enlarged configuration having a size greater than the holes 86 in the rim of the container 9 in at least one dimension so as to lock onto the container (see FIG. 6). The wings are actuated into the open and closed configuration by a suitable actuating mechanism coupled to a drive gear, but other actuating mechanisms for actuating the gripper elements known in the art are applicable in the present invention. In the specific example shown in FIG. 7, the head of at least one of the wings comprises a plurality of teeth that mesh with the drive gear such that when the gripper elements 84 are actuated by the actuating mechanism, rotation of the drive gear causes the pair of wings to rotate from a closed or collapsed configuration to an open enlarged configuration (FIGS. 7 and 8). When in the collapsed or closed configuration, the gripper elements 84 are sized to be receivable in corresponding holes 86 in the rim of the container 9 as shown in FIG. 6. The foot of each of the pair of wings comprises a stop 89, e.g. a boss, such that when received in a corresponding hole 86 in the rim of the container 9, the stop 89 engages with an underside of the rim when in an enlarged open configuration to lock onto the container when the container-engaging assembly 43 is winched upwards towards the container-receiving space 49 of the load handling device 31.

### Power Unit

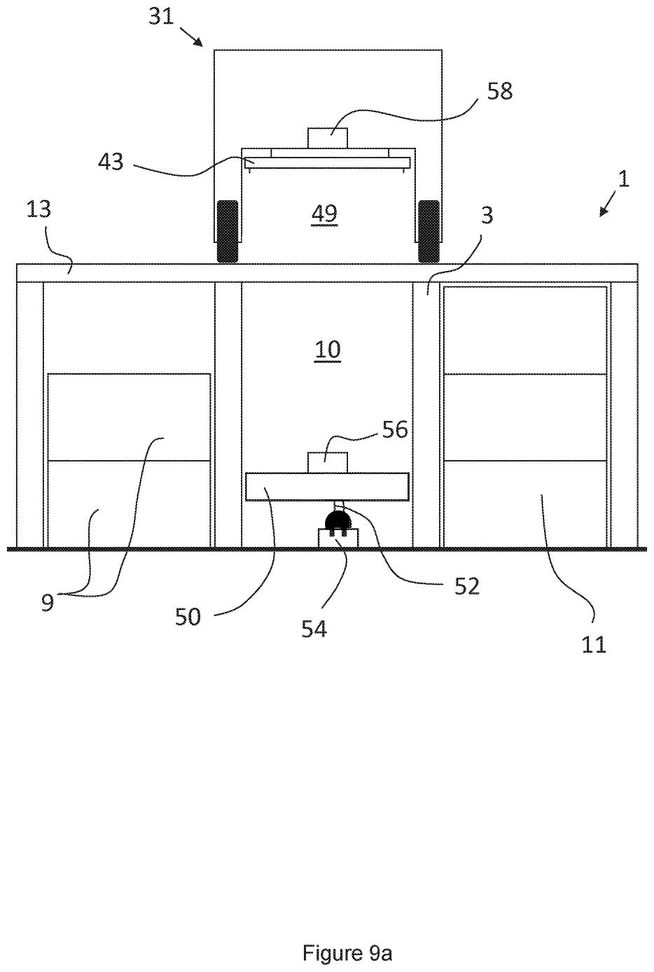

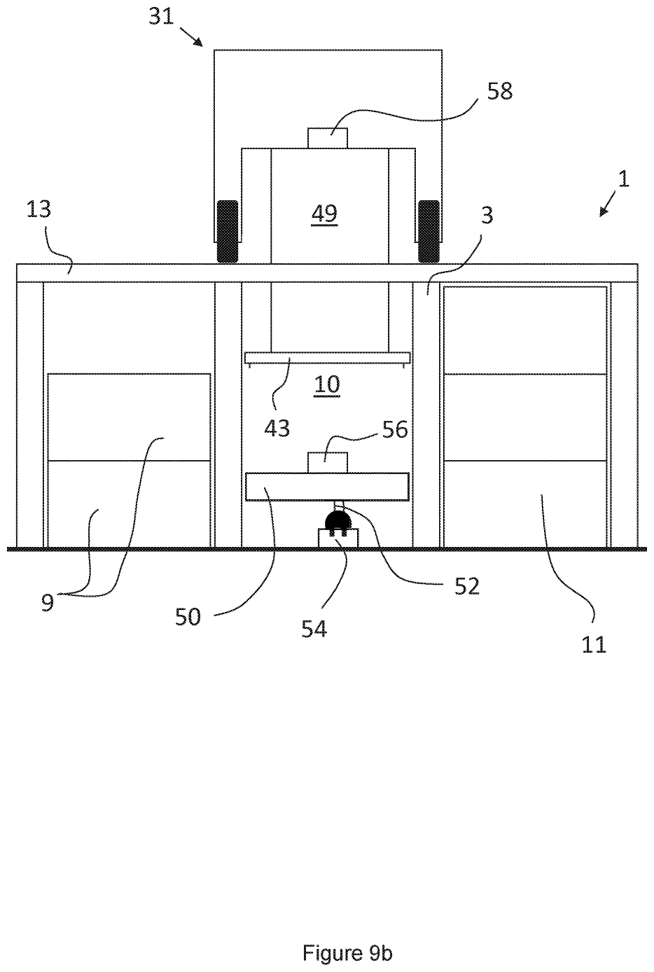

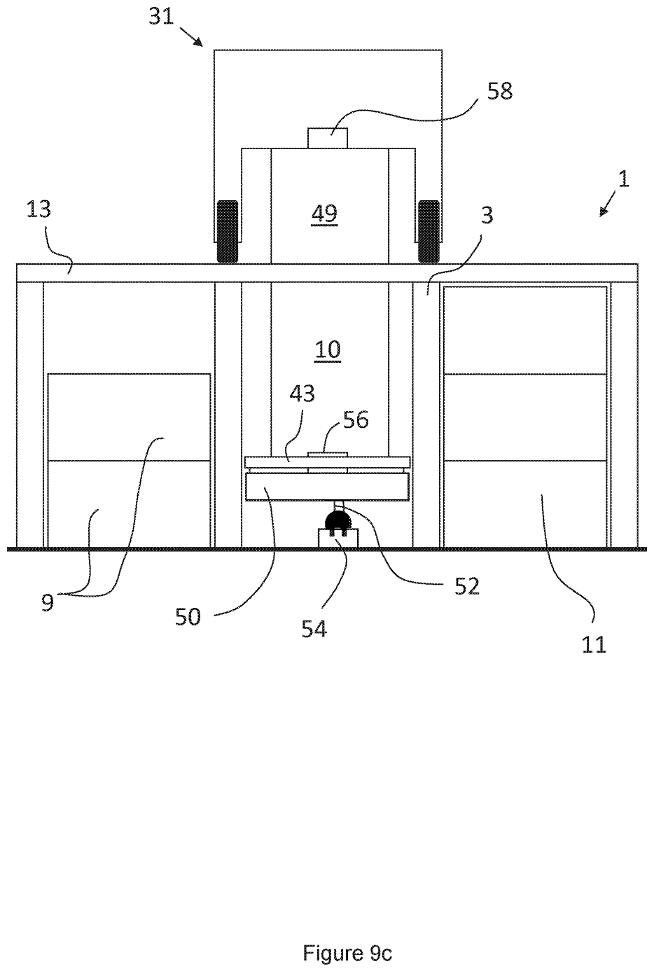

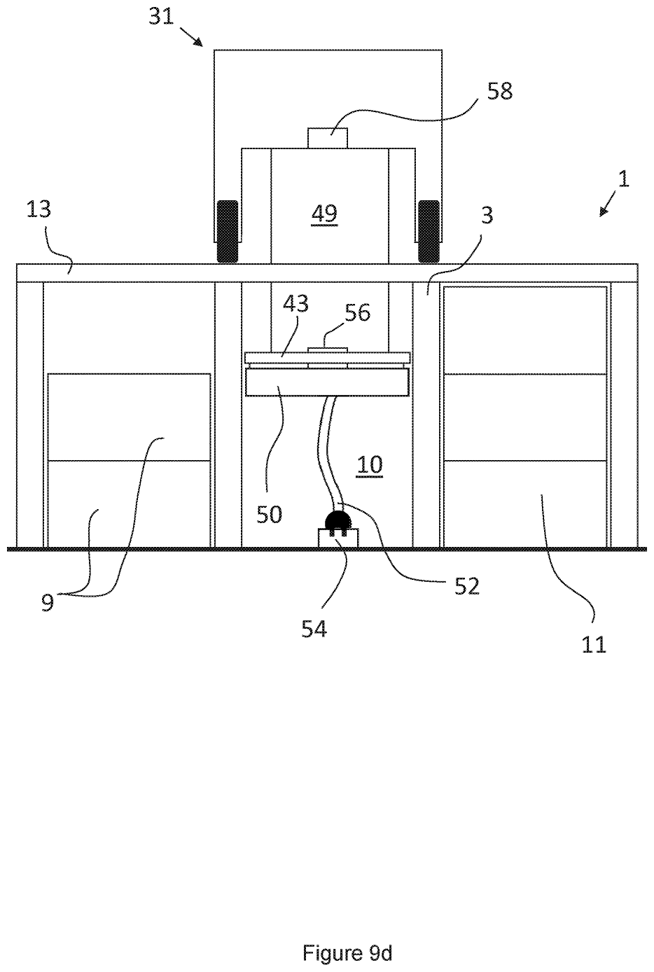

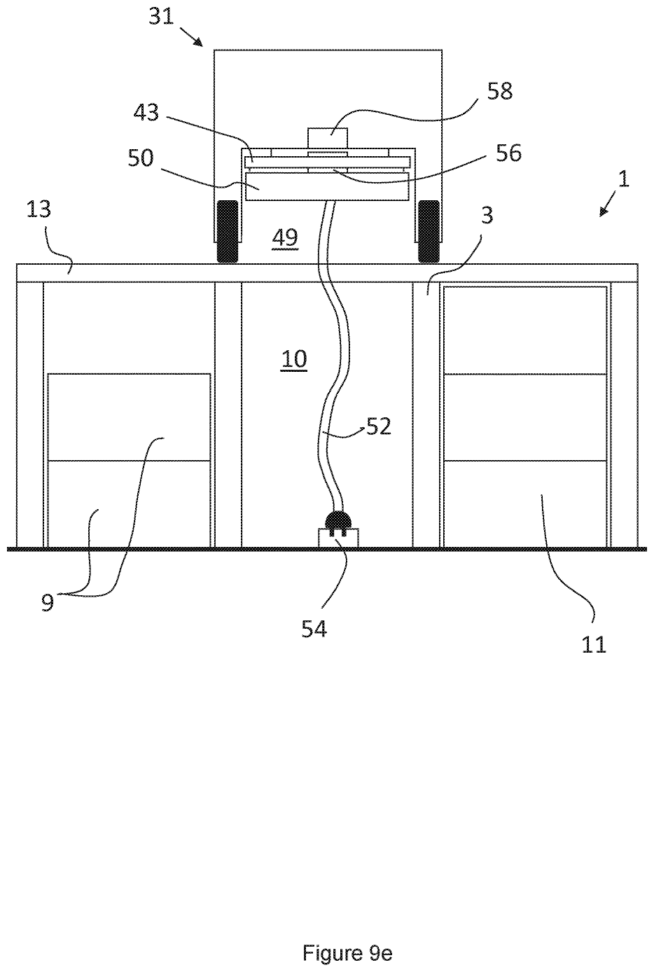

FIGS. 9a to 9e schematically illustrate an embodiment of a power unit 50. The power unit 50 is installed in a storage column 10 of a grid framework structure 1. The power unit is connected via a cable 52 to a power supply 54 at the bottom of a storage column 10. The power unit 50 comprises a power providing element 56 located on top of the body of the power unit 50. The power unit 50 occupies a storage column 10. Other storage columns 10 are used for storage of stacks 11 of storage containers 9. The storage column 10 occupied by the power unit 50 is not available to use for storage.

A load handling device 31 is illustrated on the track system 13, at a grid cell at the top of the storage column 10 where the power unit 50 is installed. The load handling device 31 comprises a lifting device 39 and a container-engaging assembly 43. Above the container-receiving space 49 is a power receiving element 58.

In use, first the load handling device 31 travels on the track system 13 to the grid space above the storage column 10 where the power unit 50 is located. Initially, as can be seen in FIG. 9a, the container-engaging assembly 43 is within the container-receiving space 49. The lifting device 39 lowers the container-engaging assembly 43 into the storage column 11 towards the power unit 50, as illustrated in FIG. 9b. When the container-engaging assembly 43 reaches the power unit 50, the container-engaging assembly 43 engages the power unit 50, as shown in FIG. 9c. The power unit 50 is provided with engagement features (not shown) to enable the container-engaging assembly 43 to engage with the power unit 50. Once the power unit is engaged, the lifting device lifts the container-engaging assembly 43 and the power unit 50 up through the storage column 10, as illustrated in FIG. 9d. The power unit 50 remains connected to the power supply 54 by means of the cable 52. The load handling device 31 continues lifting the power unit 50 until the power unit 50 is received within the container-receiving space 49, as illustrated in FIG. 9e. Again, the power unit 50 remains connected to the cable. When the power unit 50 is received within the load handling device 31, the power receiving element 58 in the load handling device and the power providing element 56 of the power unit 50 are aligned and in close proximity, so power transfer can take place. Power is transferred from the grid framework structure 1 via the cable 52 and the power unit 50 to the load handling device 31. More specifically, power is transferred from the power supply 54 fixed at the base of the storage column 10 via the cable 52 to the power unit 50, then in turn from the power unit 50 via the power providing element 56 to the power receiving element 58 in the load handling device 31.

In some examples there is a physical connection between the power receiving element 58 in the load handling device and the power providing element 56 of the power unit 50, and in other examples power is transferred wirelessly between the power unit 50 and the load handling device 31, for example by magnetic induction. In cases where there is a physical connection, the connectors on one or both sides can be resilient or spring-loaded in order to increase the number of cycles.

The power cable 52 may be connected to mains power. In some examples a voltage converter may be used to convert from the power supply voltage to the voltage used by the load handling device 31. For example, a 24V DCDC converter may be provided to convert mains voltage to 24V.

In some examples the cable 52 may be guided by a cable guide (not shown) in order to ensure that the cable does not get twisted or kinked as the load handling device 31 lifts or lowers the power unit 50 in the storage column 10.

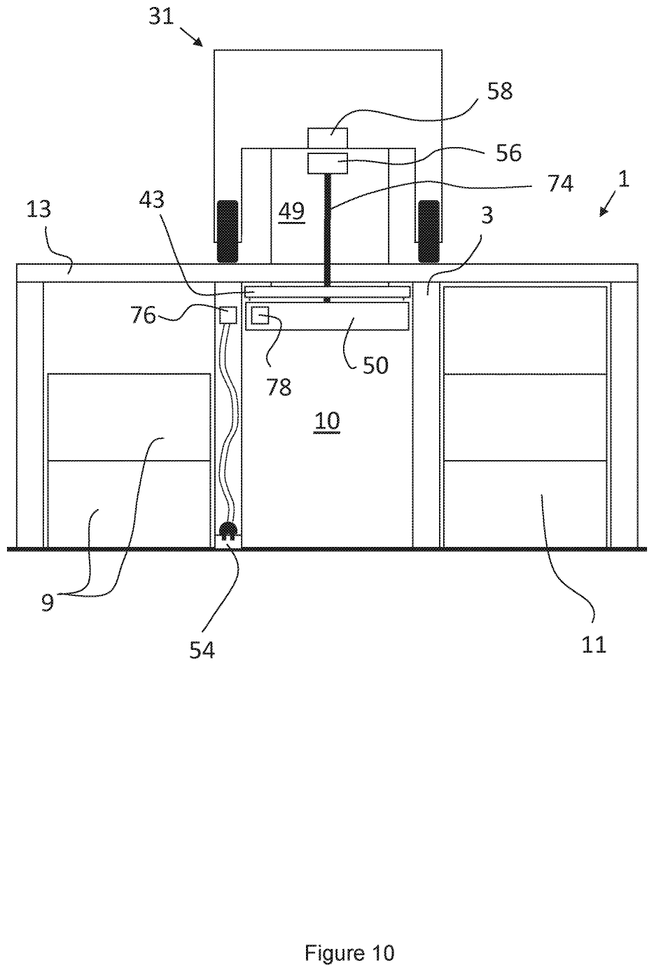

FIG. 10 schematically illustrates another example of a power unit 50 in a grid framework structure 1. In this example the power providing element 56 is mounted on a telescoping mechanism 74, so is able to move relative to the body of the power unit 50. The power unit 50, rather than being connected to the power supply 54 via a cable, receives power wirelessly. The power unit 50 comprises a power receiving element 78, which couples with a power providing element 76 mounted on one of the upright members 3 of the grid framework structure 1. The power providing element 76 is connected to the power supply 54 via a cable.

In use, the load handling device 31 moves on the track system 13 to the grid cell immediately above the storage column 10 where the power plate 50 is located, lowers the container-engaging assembly 43 into the storage column 10, engages with the power plate 50, and lifts the power plate 50 up into the container receiving space 49 of the load handling device 31 until the power providing element 56 on the power plate 50 engages with the power receiving element 58 on the load handling device 31, in the same way as described above with reference to FIGS. 9a-9e. Once the power providing element 56 on the power plate 50 has engaged with the power receiving element 58 on the load handling device, the load handling device 31 lowers the power plate 50 and activates the telescoping mechanism 74, such that the power providing element 56 and power receiving element 58 remain engaged while the power plate 50 is lowered. The power plate 50 is lowered until it reaches substantially the same vertical level as the power providing element 76 in the upright column 3, so that the power receiving element 78 in the power unit 50 is in close proximity to the power providing element 76. Power is then transferred wirelessly from the power providing element 76 in the grid framework structure 1 to the power receiving element 78 in the power unit 50.

Since the telescoping mechanism 74 allows the power connection between the power unit 50 and the load handling device 31 to be maintained, power can be transferred from the power supply 54 via the power unit 50 to the load handling device 31. More specifically, power is transferred from the power supply 54 via a cable to the power providing element 76 in the upright column 3 of the grid framework structure, then wirelessly from the power providing element 76 to the power receiving element 78 in the power unit 50, then from the power providing element 56 of the power unit 50 wirelessly to the power receiving element 58 in the load handling device 31.

In the illustrated example the power providing element 76 is located near the top of an upright column 3 and connected via a cable to the power supply 54 is located at the bottom of the upright column 3. In other examples, the power providing element may be located on the track system 13, on track supports, on other parts of the supporting framework of the grid framework structure, on an adjacent station, or any other suitable location.

In the illustrated example a telescoping mechanism is used to allow the power providing element 56 of the power unit 50 to move upwards relative to the body of the power unit 50. In other examples, the power receiving element 78 may be configured to move downwards relative to the body of the power unit 50. Other suitable mechanisms can be used in place of the telescoping mechanism 74. Other arrangements that allow relative movement of the power providing element 56 and power receiving element 78 of the power unit 50 are also applicable.

To maintain the connection between the power providing element 56 of the power unit 50 and the power receiving element 58 of the load handling device, a retaining mechanism may be used (not shown). For example, a magnet or a clip or a gripper may be used as a retaining mechanism. The retaining mechanism engages when the power unit 50 is lifted up into the container receiving space 49, and maintains the engagement between the power providing element 56 and the power receiving element 58 while the power unit 50 is lowered into the storage column 10.

### Power and Data Connections

In some examples, the power unit and load handling device may be configured to transfer data as well as power. As with power, data transfer may be effected by wireless transfer or by a physical connector. In examples where the power unit is connected to the power supply via a cable, the same cable can be used for both power and data transfer, or a separate cable can be used for data transfer.

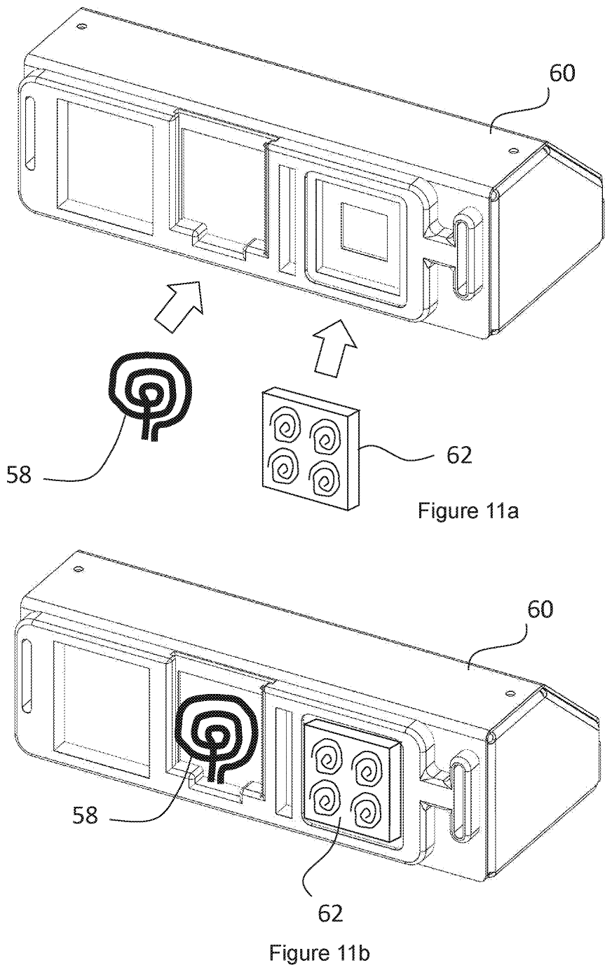

FIGS. 11a and 11b illustrate an example of power and data connections for a load handing device. The view is from underneath, so that the connections can more easily be seen. A case 60 is provided to house the power receiving element 58 and a data interface 62. In use, the case 60 is attached to the underside of the top of the container receiving space in the load handling device. FIG. 11a is an exploded view of the case 60, the power receiving element 58, and the data interface 62. The case 60 comprises recesses for holding the power receiving element 58 and the data interface 62. The power receiving element 58 in this example is an induction coil. The data interface 62 in this example is a PCB (printed circuit board) with induction coils printed onto it. FIG. 11b illustrates the power receiving element 58 and the data interface 62 within the case 60. Both power and data are transferred between the load handling device and complementary induction coils on the power unit.

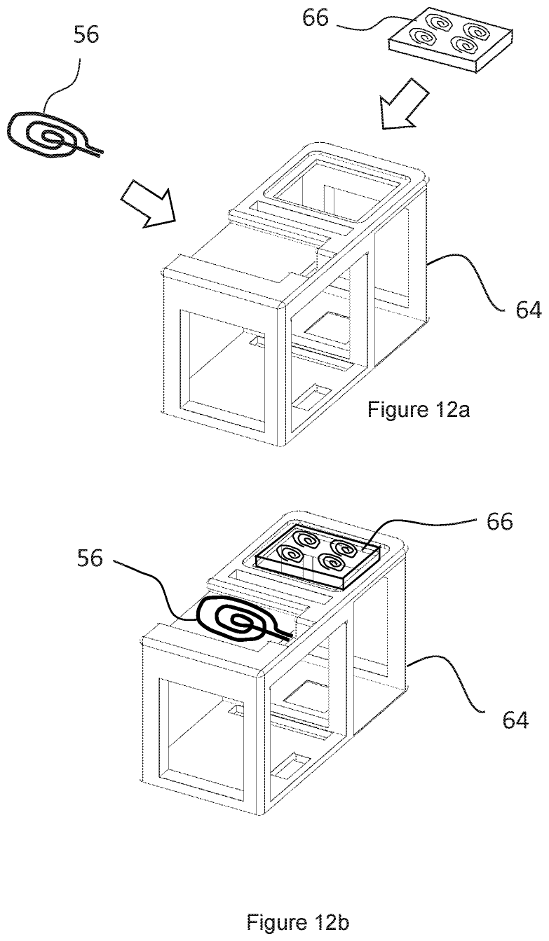

FIGS. 12a and 12b illustrate an example of power and data connections for a power unit, complementary to the connections for a load handling device illustrated in FIGS. 11a and 11b. FIG. 12a is an exploded view of a case 64, the power providing element 56, and a data interface 66. In use, the case 64 is attached to the top of the power unit. The case 64 comprises recesses for holding the power providing element 56 and the data interface 66. The power providing element 56 in this example is an induction coil, complementary to the induction coil 58 which is the power receiving element on the load handling device. The data interface 66 in this example is a PCB with induction coils printed onto it, complementary to the data interface 62 (also a PCB) for the load handling device. FIG. 12b illustrates the power providing element 56 and the data interface 66 within the case 64.

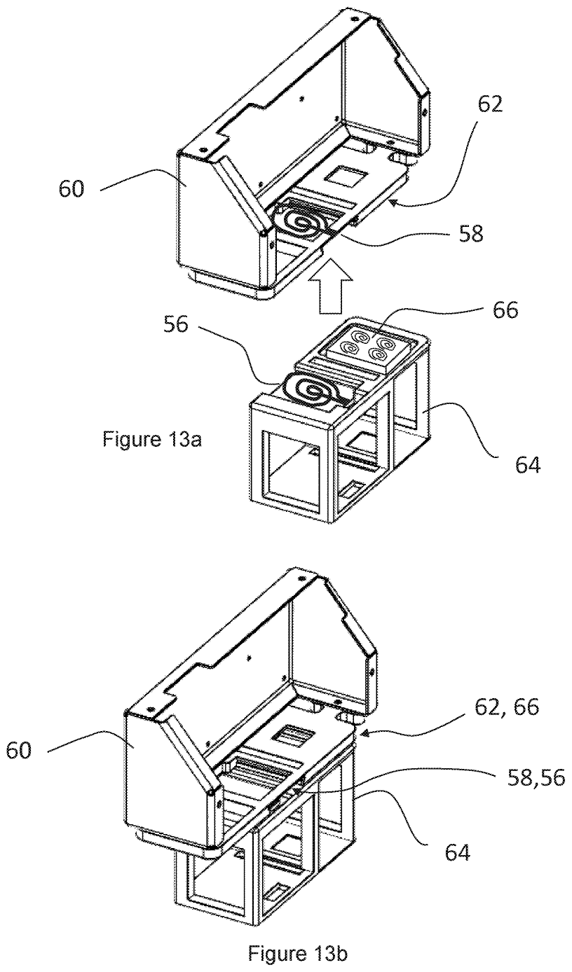

FIGS. 13a and 13b illustrate the power and data connections of FIGS. 11a, 11b, 12a, and 12b separately (FIG. 13a), and connected (FIG. 13b). Part of the case 60 has been removed for ease of illustration. In FIG. 13a the arrow represents the direction of movement, i.e. the case 64 ascends vertically as the power unit is lifted by the load handling device. When the power unit reaches the top of the container receiving space in the load handling device, the power providing element 56 on the power unit is aligned with and in close proximity to the power receiving element 58 on the load handling device, so power can be transferred from the power unit to the load handling device. At the same time the data interface 66 of the power unit is brought into close proximity with the data interface 62 of the load handling device. Data can be transferred from the power unit to the load handling device, and or from the load handling device to the power unit, via their respective data interfaces. In some examples the data interfaces can support bidirectional data transfer. Multiple induction coils may be provided on the data interfaces for this purpose, i.e. one or more coils for data transfer in one direction, and one or more induction coils for data transfer in the opposite direction.

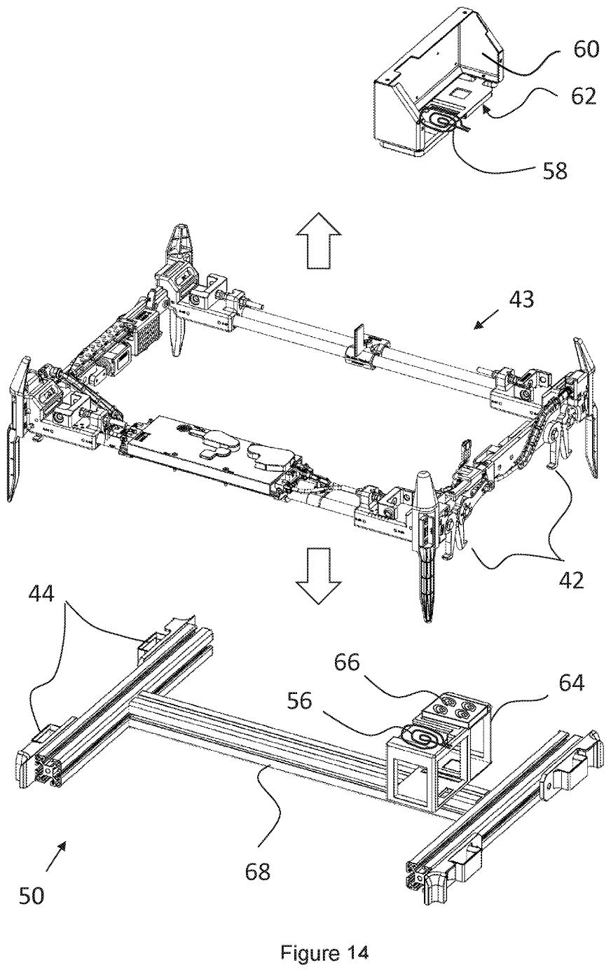

FIG. 14 illustrates the container engaging assembly 43 of a load handling device, and a power unit 50. The container engaging assembly comprises an engaging mechanism 42 as described above, for engaging with a storage container. The container engaging assembly 43 comprises the case 60 housing the power receiving element 58 and data interface 62.

The power unit 50 comprises a lightweight frame 68. Attached to the frame 68 are engagement features 44, configured to be engaged by the engaging mechanism 42 of the container engaging assembly of the load handling device. The engagement features 44 are the same kind of engagement features as on the storage containers 9, so that the container engaging assembly 43 of the load handling device can engage with the power unit in the same way as with a storage container.

The arrows represent the direction of movement of the container engaging assembly, i.e. the container engaging assembly is first lowered down the storage column to engage with the power unit, and then the container engaging assembly and power unit are lifted up the storage column into the container receiving space of the load handling device. When the container engaging assembly 43 is at the top of its travel, the case 64 of the power unit is in close proximity to the case 60 of the load handling device, so the power providing element 56 of the power unit can provide power to the power receiving unit 58 of the load handling device, and data can be transferred between the data interface 62 of the power unit and the data interface 66 of the load handling device.

FIGS. 11-14 illustrate the details of power and data connections between the power unit and the load handling device. The power connection between the power unit and the power supply can be effected by induction coils in a similar way. Alternatively, the power unit can receive power via a power cable connected to the power supply. In examples where the power unit also transfers data, data logs from the load handling device can be transferred off the power unit by induction coils in a similar way. Alternatively, the power unit can transfer data via a cable, either the same cable used to transfer power or a separate cable. Data transfer can be bidirectional, e.g. computer-executable code can be transferred via the power unit to the load handling device and/or data logs can be transferred off the load handling device via the power unit.

Although FIGS. 11-14 illustrate an example where power and data are transferred wirelessly, in other examples only power may be transferred. In other examples there may be a physical connector to transfer power, and optionally data, rather than wireless transfer. In other examples, a physical connector may be used to transfer power and a wireless connection to transfer data, or the other way round.

### Inductive Coupling

Inductive coupling is a known method of transferring power. An alternating electric current is passed through a transmitter coil. The electric current generates a magnetic field, which is time-varying at the same frequency as the alternating electric current. The magnetic field lines pass through a receiver coil and induce an electromotive force in the receiver coil. Since the receiver coil is a complete circuit, the induced electromotive force causes a current to flow. Thus, power is transferred from the transmitter coil to the receiver coil.

Induction is a useful method of power transfer because it is simple and easy to achieve. The parts are low cost and lightweight, and off-the-shelf induction coils and associated electronics are readily available.

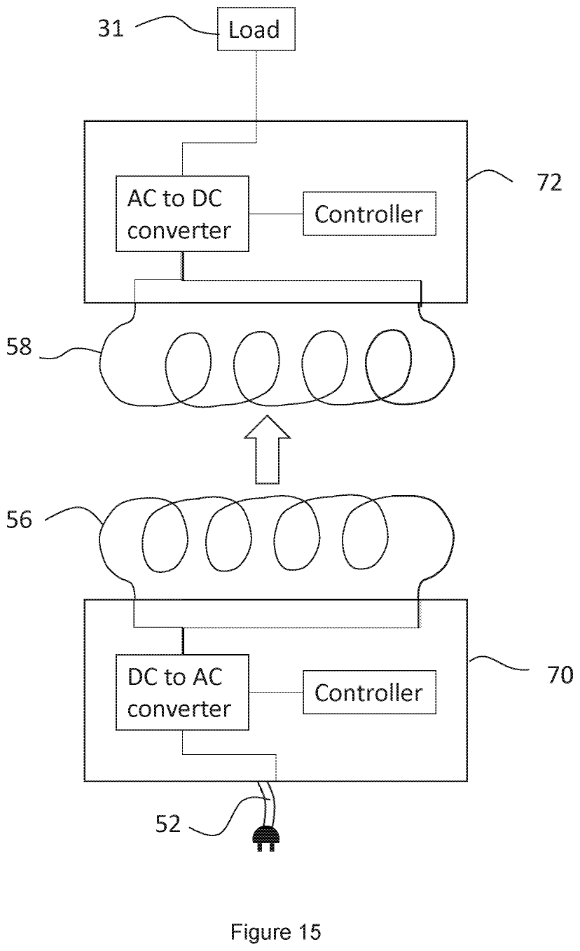

FIG. 15 is a block diagram schematically illustrating a wireless power transfer system. The wireless power system comprises a transmitter circuit board 70, a receiver circuit board 72, and transmitter and receiver coils 56, 58. The transmitter and receiver coils are used as the power providing element 56 in the power unit and the power receiving element 58 in the load handling device respectively. The transmitter circuit board 70 is powered by a 24V power supply (including mains adapter), and contains a controller (e.g. MCU=microcontroller unit) to control the wireless power transfer and a converter for converting the DC power supply to AC. The transmitter circuit board 70 is connected to and supplies power to the transmitter coil (power providing element 56). Power is transmitted via magnetic induction from the transmitter coil 56 to the receiver coil (power receiving element 58). The receiver coil 58 is connected to the receiver circuit board 72. The receiver board contains a rectifier to convert the alternating current from the receiver coil back to DC, a controller (e.g. MCU). The transmitter circuit board 70 and/or the receiver circuit board 72 may also contain other electronic components. The receiver circuit board 72 supplies power to the electrical loads in the load handling device 31.

Although not illustrated in FIG. 15, the wireless power transfer system may also be configured to transfer data.

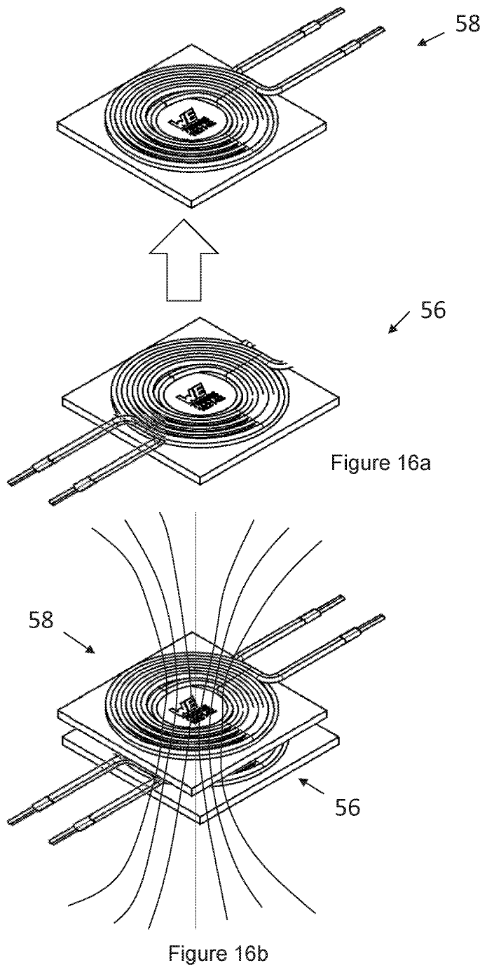

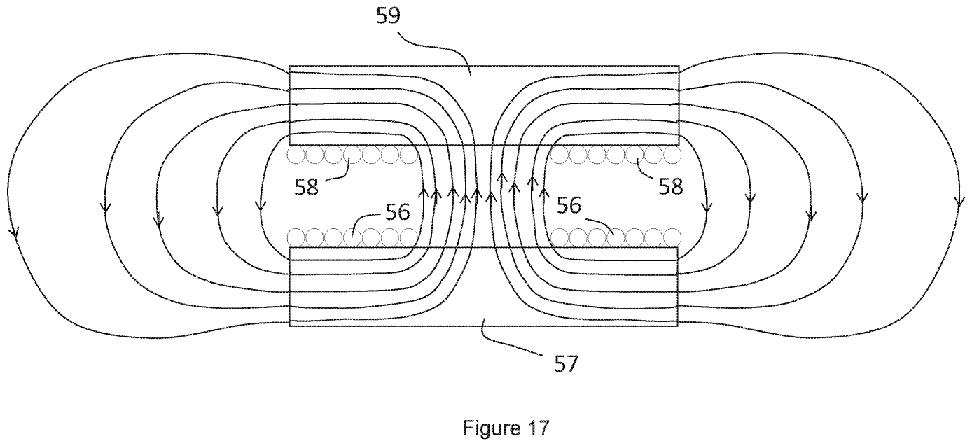

FIGS. 16a and 16b illustrate an example of commercially available induction coils suitable for use as the power providing element 56 of the power unit and the power receiving element 58 of the load handling device. In FIG. 16a the two coils 56, 58 are illustrated separately, with the arrow indicating the direction of movement as the power unit is lifted up into the container receiving space of the load handling device. In FIG. 16b the magnetic flux lines induced by the current in the transmitter coil 56 are illustrated. The shape of the coil 56 concentrates the flux lines through the centre of the coil. As the two coils 56, 58 are brought into close proximity, the coils are substantially concentric so the flux lines from the transmitter coil 56 pass through the centre of the receiver coil 58. The magnetic flux induces an electromotive force in the receiver coil 58, so power is transferred.

FIGS. 16a and 16b illustrate the shape of the magnetic flux lines for induction coils without a ferrite backing. In some examples, the induction coils may be provided with a ferrite backing to direct the magnetic flux. The ferrite material helps to contain and guide the magnetic flux so that the majority of the magnetic flux stays inside the ferrite material, thus reducing flux leakage and improving efficiency and power transfer.

FIG. 17 schematically illustrates a pair of induction coils 56, 58 acting as the power providing element 56 of the power unit and the power receiving element 58 of the load handling device. Both coils 56, 58 are provided with a ferrite backing material 57, 59. As well as supporting the coils, the ferrite material guides the flux lines. It can be seen from the figure that the magnetic flux lines pass through the gap between the backing materials 56, 58 at the centre of the two coils 56, 58, are guided by the ferrite material 59 to loop around and leave the sides of the ferrite material 59, loop around the coils 56, 58, are recaptured by the sides of the ferrite material 57, and are guided through the ferrite material 57 back to the centre of the coils 56, 58. In practice there will still be some flux leakage (flux lines that are not recaptured by the ferrite material), but the presence of the ferrite backing material helps to contain the magnetic flux and improve efficiency.

In examples where magnetic induction is used to transfer both power and data, either the same coils or separate coils can be used.

In examples where separate coils are used to transfer power and to transfer data, the coils for power transfer may be physically separated from the coils for data transfer in order to reduce interference. Alternatively or additionally, physical shielding may be used. Different frequencies may be used for power transfer and for data transfer. For example, a low frequency may be used for power transfer, and a high frequency may be used for data transfer.

Using separate coils for data transfer and for power transfer has the advantage that the coils can be optimized for different criteria. For example the frequency of the coils for power transfer may be chosen to maximize power transmission and/or to minimize power losses. A narrow bandwidth may be preferable for power transmission (e.g. a sinusoidal wave) so that the frequency can be optimized to give a high Q value.

For data transfer, conversely, the power and efficiency are less important since not much power is needed and losses do not prevent the data being received. Data may be transmitted over a wider bandwidth.

Induction coils have a resistance in addition to their inductance. The resistance of the coils dissipates energy as heat, and reduces transmission efficiency. The ratio between the resistance R and the frequency-dependent inductance L is called the loss factor, equal to R/ωL, where the frequency ω is the frequency of the alternating current in the transmission coil. The inverse of the loss factor is the Q-factor, given by Q=ωL/R. Q-factor is a dimensionless parameter that describes how damped an oscillation is. A high Q-factor represents a lower energy loss per cycle of the oscillation, therefore a higher efficiency of transmitting power. The higher the frequency ω of the alternating current in the transmission coil, the greater the power losses. The Q factor can also be defined as 2π (maximum energy stored per cycle)/(energy dissipated per cycle).

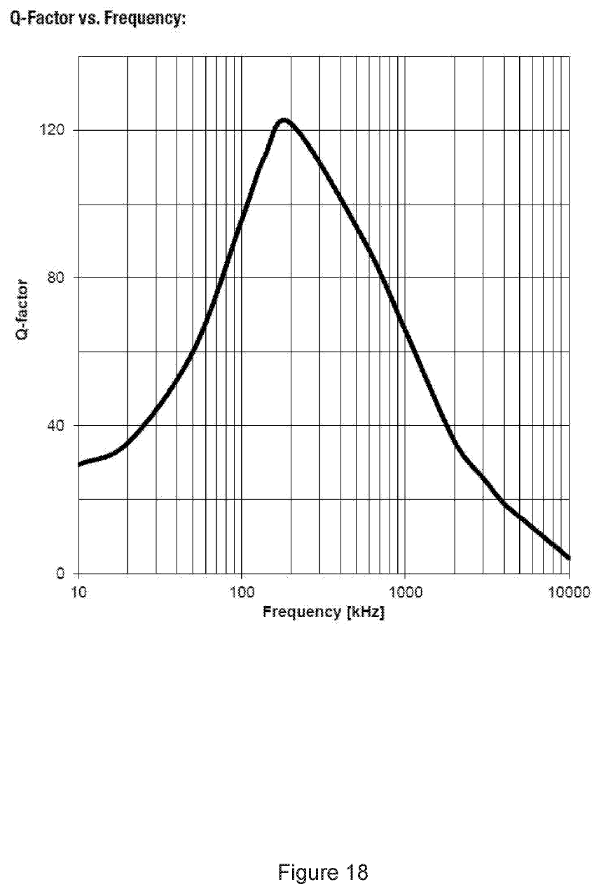

FIG. 18 is a graph of Q-factor against frequency for the induction coils illustrated in FIGS. 16a and 16b. It can be seen that the optimum frequency for efficient transmission is just below 200 kHz. For power transfer, the frequency of the coils may be chosen to maximize the Q-factor (i.e. to minimize losses). A wider bandwidth is required for data transfer, however, so the losses across some of the bandwidth will be higher. Resonant inductive transfer gives better efficiency and enables transfer over longer distances, but the resonance is in a narrow band. This is acceptable for power transfer (a single frequency/narrow bandwidth). For data transfer, however, a wider bandwidth is needed rather than a simple sine wave at a single frequency. Using separate coils permits the power transfer to be optimized for efficiency and the data transfer to be optimized for bandwidth. Also, bidirectional data transfer is possible.

The resonant frequency can change depending on factors such as the distance between the coils and the temperature. In some examples the transmission frequency can be dynamically adjusted in order to remain in the resonant/high Q-factor part of the curve illustrated in FIG. 18. In cases where power and data are transmitted through separate pairs of induction coils, the magnitude of the voltage received through the data coils can be used as an indication of how close the transmission frequency is to the resonant frequency. The controller can then use this information to adjust the frequency of transmission for the power transmitting coil.

Using the same coils for both power and data transfer is another option, and has the advantage of reducing part count, cost, weight, and complexity. In that case, a suitable frequency range can be chosen for an optimum balance between efficiency and bandwidth.

### Power Source Exchange Station

An important application for the power unit is to provide power to a load handling device during a power source exchange operation. In some examples of storage and retrieval systems, instead of the load handling device travelling to a charge station in order to recharge its power source when the power source is depleted, the load handling device instead travels to an exchange station, where the depleted power source is removed and replaced with a fully-charged power source. This has the advantage of improved operational efficiency, since the exchange operation is completed quickly and non-operational time reduced, rather than the load handling device needing to wait until the power source is recharged.

A disadvantage of exchanging the power source is that the load handling device is temporarily without a power source, in the time between a power source being removed and a fresh power source being installed. This is a problem when in the load handling device has critical components that need to be continually supplied with power, for example communications, monitoring, and safety systems. An auxiliary power source can be used to keep these critical components operational while the power source is being exchanged, but this requires an additional part with associated increase in cost weight, and complexity of the load handling device. Using the power unit to provide power during the exchange operation means that no auxiliary power source is needed. In examples where the power unit also provides data transfer, the data transfer can take place at the same time as exchanging the power source, thus saving time by negating the need for a separate operation.

A power unit can be provided in a storage column adjacent or close to each exchange station in a storage and retrieval system.

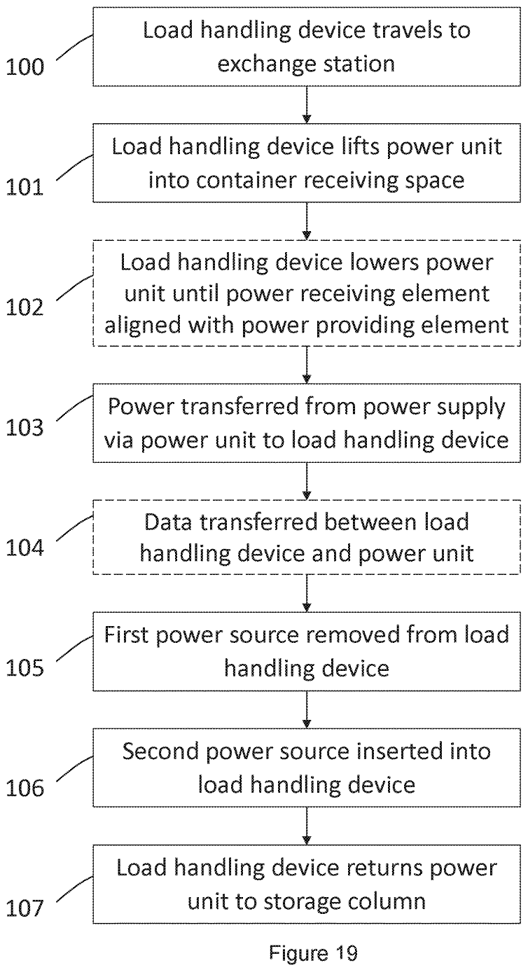

FIG. 19 is a flowchart illustrating a method of using the power plate during a power source exchange operation. In a step 100, a load handling device travels to an exchange station. The load handling device pauses on the grid cell directly above the storage column containing a power unit. In a step 101, the load handling device lifts the power unit into the container receiving space. This allows the power connection to be made between the power unit and the load handling device. The power providing element of the power unit engages with the load handling device.

In examples where the power unit is connected to the power supply by a cable, power can now be transferred from the power source via the power unit to the load handling device. In examples where the power unit receives power wirelessly, however, an extra step 102 (indicated on the flowchart with a dashed line) is necessary. In the step 102, the load handling device lowers the power unit until the power receiving element of the power unit is aligned with the power providing element connected to the power supply. The power connection between the power unit and the load handling device is maintained during this step.

In either case, in a step 103, power is transferred from the power supply via the power unit to the load handling device.

In cases where the power unit also provides a data connection, in a step 104 (indicated on the flowchart with a dashed line) data is transferred between the load handling device and the power unit. Data transfer may be bidirectional.

Once the power connection is made so that critical components of the load handling device are supplied with power from the power supply, the exchange operation can take place. In a step 105, a first power source is removed from load handling device. This may be a depleted power source. In a step 106, a second power source is inserted into the load handling device. This may be a fully charged power source.

Finally, in a step 107 the load handling device returns the power unit to its previous position by lowering the power unit into the storage column.

### Temporary Storage of Load Handling Devices

Storage systems can experience variable demand, for example at different times of the year or a higher demand around holidays. It is an advantage if the system can adapt quickly to variable demand by making extra load handling devices available at short notice during busy periods, while saving energy and operating costs by storing load handling devices when not in use.

One option is to remove load handling devices from the track system when not required, either by storing them in a maintenance area or removing from the storage system entirely. However, when the load handling devices are required again, they need to be returned to the track system and recommissioned. This can take some time, and means that the system cannot immediately respond to increased demand.

Another application for the power unit is to maintain power to a load handling device on the track system when the load handling device is not required. The power connection can be maintained, so that the critical components (e.g. communications systems, safety systems) of the load handling device are kept active while the load handling device is parked on the track system. The power demand during temporary storage is low, just enough to maintain power to critical components.

In some examples, in addition to maintaining power to critical components, the power unit can trickle-charge the power source of the load handling device in order to maintain a given state of charge. This means that the power source does not fully discharge while the load handling device is inactive, so when the load handling device is required to be operational again the power source is charged and ready, so the load handling device can be brought back into operation with no delay.

The load handling device can be parked on an area of the track system that is less frequently used. In examples where the power unit is moveable rather than permanently occupying a storage column, then if a given product is required from that storage column the load handling device can move away from the storage column so that the product is accessible. The container with the given product can be picked by a different load handling device, or by the same load handling device (after the load handling device has first deposited the power unit in another storage column).

In examples where the power unit also provides a data link, the data link can be used to check the status of the power source of the load handling device. If the state of charge of the power source is too low (for example, below a predetermined threshold state of charge or voltage level), the control system may instruct the load handling device to travel to an exchange station to exchange the power source.

In other examples where immediate deployment of load handling devices in temporary storage is not required, the load handling device may engage with a power unit as described above and turn off all systems (including critical components), and “wake up” periodically to communicate with the control system of the storage system and check whether the load handling device is required. If the load handling device is not required, it can power down again until the next periodic check-in time. The advantage of this strategy is that power consumption is even lower, but the load handling device can enter operation again at relatively short notice. The interval between the periodic check-ins can be adjusted to find the optimum balance between power consumption and speed of deployment when required.

What is claimed is:

1. A power unit for providing power to a load handling device operative on a grid framework structure, the power unit comprising:
a power providing element configured to transfer power to at least one power receiving element in the load handling device; and
a power receiving element configured to receive power from a power supply;
wherein the power unit is configured to be lifted into a container-receiving space of the load handling device such that, when received within the container receiving space of the load handling device, power is transferred from the power supply to the load handling device via the power unit.

2. The power unit of claim 1, wherein the power receiving element of the power unit is configured to receive power from the power supply via a cable.

3. The power unit of claim 1, wherein the power receiving element of the power unit is configured to receive power wirelessly from a power providing element connected to the power supply.

4. The power unit of claim 3, wherein the power providing element and the power receiving element of the power unit are configured to move relative to one another such that, when the power unit is received within the load-handling device, the power receiving element of the power unit is configured to align with the power providing element connected to the power supply such that power can be transferred.

5. The power unit of claim 1, wherein the power providing element of the power unit and the power receiving element of the load handling device are induction coils, and the induction coil of the power unit is configured to transfer power to the induction coil of the load handling device by magnetic induction.

6. The power unit of claim 5, wherein the induction coil on the power unit is printed onto a PCB.

7. The power unit of claim 1, further comprising a data interface configured to transfer data between the power unit and the load handling device, optionally wherein the data interface is configured to support bidirectional data transfer between the power unit and the load handling device.

8. The power unit of claim 7, wherein the data interface comprises an induction coil for data transfer, configured to transfer data to and/or from a corresponding induction coil of the load handling device by magnetic induction.

9. The power unit of claim 8, wherein the induction coil for data transfer on the power unit is printed onto a PCB, optionally wherein the induction coil for power transfer and the induction coil for data transfer are printed onto the same PCB.

10. A load handling device for moving storage containers on a grid framework structure, the load handling device comprising:
a wheel assembly;
one or more critical components that are required to be operational at all times while the load handling device is on the grid framework structure;
a container receiving space for receiving a storage container;
a lifting device configured to lift the storage container into the container receiving space;
a power receiving element configured to receive power from a power providing element of a power unit as defined in claim 1;
wherein the lifting device is configured to lift the power unit into the container receiving space of the load handling device, such that the power receiving element of the load handling device receives sufficient power from the power providing element of the power unit to operate the one or more critical components of the load handling device.

11. The load handling device of claim 10, wherein the power receiving element of the load handling device and the power providing element of the power unit are induction coils, and the induction coil of the load handling device is configured to receive power from the induction coil of the power unit by magnetic induction, optionally wherein the induction coil of the load handling device is printed onto a PCB.

12. The load handling device of claim 10, further comprising a data interface configured to transfer data to or receive data from the power unit when the power unit is received in the container receiving space, optionally wherein the data interface is configured to support bidirectional data transfer between the load handling device and the power unit.

13. The load handling device of claim 12, wherein the data interface comprises an induction coil configured to transfer data to and/or from a corresponding induction coil of the load handling device by magnetic induction.

14. The load handling device of claim 13, wherein the induction coil for data transfer is printed onto a PCB, optionally wherein the induction coil for power transfer and the induction coil for data transfer are printed onto the same PCB.

15. An exchange station for exchanging power sources in a load handling device as claimed in claim 10, the exchange station comprising:
a transfer mechanism for removing/inserting a power source from/into the load handling device; and
a power unit;
wherein the power unit is configured to provide sufficient power to operate the one or more critical components of the load handling device while the power source is being exchanged.

16. A storage and retrieval system comprising:
a grid framework structure comprising:
i) a track system comprising a plurality of tracks arranged in a grid pattern;
ii) a supporting framework structure supporting the track system; and
iii) a plurality of stacks of storage containers arranged in a plurality of storage columns located below the track system;
at least one load handling device;
at least one exchange station; and
at least one power supply for providing power to the power unit of the at least one exchange station.

17. A method of transferring power to a power source in a load handling device, the method comprising the steps of:
controlling a load handling device to travel to an exchange station;
the load handling device engaging with the power unit and lifting the power unit through a grid cell into the container receiving space of the load handling device; and
power being transferred from the power supply to the load handling device via the power unit.

18. The method of claim 17, wherein the power providing element and the power receiving element of the power unit are configured to move relative to one another such that, when the power unit is received within the load-handling device, the power receiving element of the power unit is configured to align with the power providing element connected to the power supply such that power can be transferred, and the method further comprises the step of the load handling device lowering the power unit until the power receiving element of the power unit is aligned with the power providing element connected to the power supply, while the power providing element of the load handling device remains engaged with the power providing element of the power unit, in order for power to be transferred from the power supply to the load handling device via the power unit.

19. The method of claim 17, further comprising the step of data being transferred between the load handling device and the power unit.

20. The method of claim 17, further comprising the steps of:
a first power source being removed from the load handling device;
a second power source being inserted into the load handling device; and
the load handling device returning the power unit to the grid cell;
such that the power unit provides sufficient power to operate the one or more critical components of the load handling device while the power source is being exchanged.
